(19) United States
(12) Patent Application Publication
(10) Pub. No.: US 2005/0098272 A1
(43) Pub. Date: May 12, 2005

(54) Universal window treatment hardware system

(76) Inventor: Deborah J. Rizzo, Gibsonia, PA (US)

Correspondence Address: EDMOND S. MIKSCH, 3825 GREEN VALLEY DRIVE, PITTSBURGH, PA, 15235, US

(21) Appl. No.: 10/705,576

(22) Filed: Nov. 10, 2003

(51) Int. Cl. E06B 9/00

(52) U.S. Cl. 160/38

(57) ABSTRACT

A suspension system for curtains, drapes, blinds, swags, cornices, or other types of window treatment includes a mounting fixture which is for attachment to a window frame or a wall adjacent a window. The mounting fixture has one or more elongate cavities, each cavity having an open end and a closed end. The fixture is for mounting with the open end of the cavities upward. The system also includes one or more brackets, rods cornices, or other window treatment components, each component including a cavity engaging portion for insertion into one of the cavities of the fixture so that the component is supported on the closed end of the cavity.

### FIELD OF THE INVENTION

The present invention relates to mounting hardware for curtains, drapes, blinds, swags and other window treatments.

### BACKGROUND OF THE INVENTION

A variety of window treatment systems exist and these, generally, require different types of mounting hardware. Window treatment systems include curtains, drapes, valances, Venetian blinds, roll blinds, swags, etc. When one window treatment system is being replaced by another, it is generally necessary to remove the old mounting hardware and install new hardware. Preferably, the old fastener holes on the wall or window frame are filled and positions for new holes are marked and holes are drilled for the new hardware. The task of positioning the new holes may require temporarily positioning the new window treatment system to determine the most pleasing position for the window treatment and hence, the best positions for the hardware.

This situation has been exacerbated in recent years by an abundance of new types of window treatments and the current practice of changing window treatments rather frequently. This is a practice being encouraged by interior decorators. The practice necessitates frequent changes in the hardware.

The background technology for window treatment hardware includes a number of patents that describe hardware elements that can accommodate two or more types of window treatment, or that provide for adjustment of the mounting hardware.

U.S. Pat. No. 915,598: This patent teaches a hanger for a shade roller. The system includes a corner bracket attached at the corner of a window. The bracket has flanges (resembling louvers) in alternating pairs. The hanger has corresponding flanges and can be slid in horizontally to engage the bracket. The hanger can be attached at several different elevations on the bracket.

U.S. Pat. No. 1,373,333: A fixture is described for supporting a shade roller and two curtain rods The bracket for the shade roller can be adjusted horizontally. The fixture has the virtue is that it can be made by stamping.

U.S. Pat. No. 2,650,053: A curtain rod bracket carrier is taught which is raised and lowered by cords. It has three vertical slots and holes for the cords, and a felt pad to prevent scratching the window frame or wall. Various types of brackets for curtains and traverse rods can be attached to the carrier.

U.S. Pat. No. 2,689,103: A vertically elongate rectangular base plate has inturned spaced apart parallel flanges along its vertical edges. Various accessories for curtains, traverse rods, valances, etc can be attached to the base plate. The accessories are inserted vertically and have flange portions that fit behind the flanges on the base plate. Screws enable these to be fixed at any elevation. Some have lateral portions for lateral positioning of the hardware they support.

U.S. Pat. No. 3,005,615: A basic element bracket is formed as a box with two sides missing. Slots and holes are provided in the existing sides. One side is attached to the wall. The side remote from the wall is missing and the side toward the window is missing. Various secondary elements can be attached to the basic element bracket and some of these secondary elements have slots for adjustment. All are for adjustably holding supports for curtain rods, Venetian blinds, valances or cornices.

U.S. Pat. No. 3,160,384: One portion is permanently attached to the wall. The portion attached to the wall has bars extending diagonally outwardly and upwardly. A plate with tongues extending downwardly and inwardly is engaged with it. The plate has a beam extending out from the wall which supports a curtain. The plate can be put at several different elevations. The inventor speaks of resisting torque. (The curtains are some distance out from the wall)

U.S. Pat. No. 3,241,684: This invention includes adjustable traverse drapery rod brackets, both for the ends of the traverse rod and for its center. A wall mountable bracket has a vertical slot for enabling vertical height adjustments for the brackets at the ends and at the center of the traverse rod.

U.S. Pat. No. 4,120,474: This is similar to U.S. Pat. No. 2,689,103 in having a vertical member with inturned flanges. Viewed from above, it has a C-shaped cross section. The back of the C is attached to the wall. A square nut fits inside the C, and a bracket outside of the C, pressed against the flanges, is held by a screw engaging the nut. Vertical adjustment is provided by the position of the nut. The bracket is for a drapery rod, sheer, etc.

U.S. Pat. No. 4,167,261: L-shaped plates are attached at each upper corner of a window. The plates have many preformed (threaded?) holes and many slots for attachment of mounting brackets for window treatments.

U.S. Pat. No. 4,179,091: A mounting plate includes flanges with holes for mounting to a wall. The mounting plate has a vertical slot and a square nut behind the slot. A drapery bracket is attached to the nut by a screw, so the drapery bracket can be adjusted up and down the slot.

U.S. Pat. No. 6,135,403: A mount for supporting the ends of parallel hung curtain rods has telescoping male and female members pivotally mounted on a base with a tensioning screw. Connectors for receiving the ends of the curtain rods are mounted on remote ends of the telescoping male and female members. The distance between the connectors and the angle of an axis intersecting the connectors can be adjusted by loosening the tensioning screw and then tightening it to fix the connectors and, hence, the curtain rods in a desired disposition.

Much ingenuity is seen in the patents described above. Nevertheless, none provide a universal mounting system for window treatment hardware.

### INTRODUCTION TO THE INVENTION

In years past, curtains, drapes or blinds hung in our homes for years and were only taken down for annual cleaning. The brackets that attached them to the wall or window frame remained in place indefinitely. Times have changed. Media programming has many venues focused on home improvement and decorating, and many consumer dollars are being spent in that direction. The present invention will enable homeowners to change window treatments without the use of tools—no more patching plaster. Once the wall hardware of the present invention is installed, it can remain permanently in place. Any type of rod, sconce, etc can then be attached to it, allowing the homeowner to change the look of a room very easily.

The purpose of the present invention is to provide a universal mounting fixture for mounting hardware for all of the common types of window treatment including curtains, drapes, blinds, valances, swags, etc. so that when window treatments are changed, it is unnecessary to remove any hardware that is attached to the wall. It is intended that the mounting fixture be left in place indefinitely, regardless of the type of window treatment that is to be attached.

In residential applications, homeowners will be able to replace their window treatments using this new system instead of the conventional bracket/rod combination now in use. The guest room can be converted to a nursery, to a toddler's room, to a child's room, then a teenager's room and then back to a guest room without ever drilling another hole.

This product can also be marketed through new home builders as an installed package to make moving in much easier. A builder can even place solid wooden blocks in the wall behind the fixture so it need not rely on attachment to wallboard or plaster. The universal mounting fixture can also used in apartment buildings. Tenants will be free to buy the rods for their individual decorating preferences, and expense from wall damage would be eliminated.

In commercial applications, firms can easily change window treatments in accordance with displays. Upscale hotels can cater to specific needs and preferences of their guests.

The universal mounting fixture is designed so that the ends of curtain rods, or brackets made to work with the fixture, can be inserted from above into the universal mounting fixture, and remain in place by virtue of their weight.

Accordingly, it is an objective of the present invention to provide a universal mounting fixture for attachment to a window frame or a wall adjacent to a window frame; the universal mounting fixture providing for attachment of any type of window treatment hardware which is made for attachment to it.

It is another objective of the present invention to provide a universal mounting fixture for window treatment hardware which can accommodate simultaneously a plurality of window treatment components, such as curtains, drapes, blinds, valances, etc.

It is a further objective of the present invention to provide a universal mounting fixture for window treatment hardware which never needs to be removed.

It is an additional objective of the present invention to provide a universal mounting fixture for window treatment hardware which makes further attachment of hardware to the wall or window frame unnecessary.

It is an additional objective of the present invention to provide a universal mounting fixture for window treatment hardware so curtains, blinds, etc, can be easily changed with the seasons in response to changes in sunlight or appearance of the outdoor environment.

In addition to the various objectives and advantages of the present invention which have been generally described above, there will be various other objectives and advantages of the invention that will become more readily apparent to those persons who are skilled in the relevant art from the following more detailed description of the invention, particularly, when the detailed description is taken in conjunction with the attached drawing figures and with the appended claims.

### SUMMARY OF THE INVENTION

In one aspect, the present invention is a suspension system for curtains, drapes, blinds, swags, scarves, or other types of window treatment. The suspension system includes a mounting fixture that includes a window frame or wall engaging portion, the window frame or wall engaging portion being attachable to a window frame or a wall adjacent a window. The mounting fixture further includes one or more cavity defining portion(s), each enclosing an elongate slotted cavity. The cavity defining portion(s) is/are integral with or attached to the window frame or wall engaging portion. Each cavity has a first end that is open and a second end that is closed by an end closure or blocking member. The mounting fixture is mountable on the window frame or wall with the cavitie(s) substantially vertical, the first end disposed above the second end.

The suspension system further includes one or more bracket, rod, valence or other window treatment component, the window treatment component including a mounting fixture engaging portion for attachment to the mounting fixture. The mounting fixture engaging may be attached to the mounting fixture by inserting it into the cavity through its first end, whereby the window system treatment element is supported on the end closure or blocking member of the second end of the cavity.

In another aspect, the present invention is a mounting fixture for a suspension system for curtains, drapes, blinds, swags, scarves, or other types of window treatment. The mounting fixture includes a window frame or wall engaging portion, the window frame or wall engaging portion being attachable to a window frame or a wall adjacent a window. The mounting fixture includes one or more cavity defining portion(s) enclosing at least one elongate cavity, the cavity defining portion(s) being either attached to or integral with the window frame or wall engaging portion. Each elongate cavity communicates with a slot disposed in the cavity defining portion that contains the cavity. The elongate cavity includes a first end and a second end, the first end being open and the second end being closed by an end closure or blocking member. The mounting fixture is mountable with the elongate cavity substantially vertical, so that the first end is disposed above the second end.

The mounting fixture is engageable by at least one bracket, rod, cornice or other window treatment component, the at least one window treatment component including a cavity engaging portion for attachment to the mounting fixture by insertion into the cavity through the first end of the cavity, whereby the window system treatment component is supported on the end closure or blocking member at the second end of the cavity.

In another aspect, the suspension system further is a bracket, rod, valence or other window treatment component, the window treatment component including a mounting fixture engaging portion for attachment to a mounting fixture having an elongate cavity, the elongate cavity having a first end that is open and a second end that is closed or blocked. The mounting fixture engaging portion of the window treatment component may be attached to the mounting fixture by inserting it into the cavity through the first end of the cavity, whereby the window treatment component is supported on the end closure or blocking member at the second end of the cavity.

### DESCRIPTION OF THE DRAWINGS

FIG. 1 is a sketch of a suspension system including a mounting fixture and a bracket for a drapery rod, according to the present invention.

FIG. 2 is an illustration of the suspension system of FIG. 1 assembled.

FIG. 3 is an illustration of a mounting fixture attached to a window frame or wall adjacent a window, according to the present invention.

FIG. 5 illustrates a mounting fixture having a cylindrical cavity and a bracket having a cylindrical cavity engaging portion.

FIG. 6 is a top view of a mounting fixture having a blocking member for support of a bracket.

FIG. 7 is a front view of the mounting fixture shown in FIG. 6.

FIG. 8 is an illustration of a mounting fixture having mounting holes disposed between cavity defining portions.

FIG. 9 is an alternative mounting fixture having at least one cavity having a rib with two flanges.

FIG. 10 is a top view of a bracket for a rod for rod pocket curtains.

FIG. 11 is a side view of the bracket of FIG. 10.

FIG. 12 is a top view of a rod for rod pocket curtains which includes a cavity engaging portion for engagement with a mounting fixture.

FIG. 13 is a side view of the rod shown in FIG. 12.

FIG. 14 is an illustration of a bracket for a traverse rod.

FIG. 15 is an illustration of a cornice having a cavity engaging portion for engagement with a mounting fixture.

FIG. 16 is a top view of a bracket for the right side of a roll blind, the bracket including a cavity engaging portion.

FIG. 17 is a side view of the bracket shown in FIG. 16.

FIG. 18 is a top view of a bracket for the left side of a roll blind, the bracket including a cavity engaging portion.

FIG. 19 is a side view of the bracket shown in FIG. 18.

FIG. 20 is a top view of a bracket for Venetian blinds.

FIG. 21 is a side view of the bracket shown in FIG. 20.

FIG. 22 is a bracket for a scarf or swag, the bracket including a cavity engaging portion.

FIG. 23 is an illustration of a mounting fixture with a bracket for supporting a drapery rod above the top of the fixture.

### IDENTIFYING NUMERALS EMPLOYED IN THE DRAWINGS

10 Suspension System
12 Window frame
14 Window
16 Wall adjacent window
20 Mounting Fixture
22 Mounting plate with holes
24 Holes in mounting plate
26 Cavity defining portion having ribs with one flange
28 Rib with one flange
29 Flange
30 Rectangular elongate cavity
32 First end of cavity
34 Second end of cavity
36 End closure
38 Blocking member
39 Slot (rectangular cavity)
40 Mounting fixture having mounting holes disposed between cavity defining portions
42 Mounting plate having holes between cavity defining portions
50 Mounting fixture having at least one rib with two flanges
52 Cavity defining portion having at least one rib with two flanges
54 Rib with two flanges
60 Mounting fixture with cylindrical cavity
62 Cavity defining portion for cylindrical cavity
64 Cylindrical cavity
66 Slot communicating with cylindrical cavity
70 Drapery rod bracket having rectangular cavity engaging portion
72 Rectangular cavity engaging portion
74 Drapery rod bracket having cylindrical cavity engaging portion
78 Cylindrical cavity engaging portion
80 Portion of drapery rod bracket extending outwardly through the slot
82 Concave support area
90 Bracket for rod for rod pocket curtains
91 Portion of bracket for passing through slot
92 Rod for rod pocket curtains
93 Upward protuberance
95 Hole in top of rod
96 Curtain rod for rod pocket curtains having cavity engaging portion thereon
97 Portion for passing outwardly through slot
98 Bracket for traverse rod for curtains
99 Traverse rod
100 Cornice having cavity engaging portion thereon
102 Bracket for roll blinds (Right side)
104 Bracket for roll blinds (Left side)
106 Bracket for Venetian blinds
107 Lid of Venetian blind bracket
110 Bracket for swag or scarf
120 Bracket for drapery rod having length of cavity engaging portion in excess of length of cavity
121 Long cavity engaging portion
130 Mounting fixture with blocking members

### DETAILED DESCRIPTION OF THE INVENTION

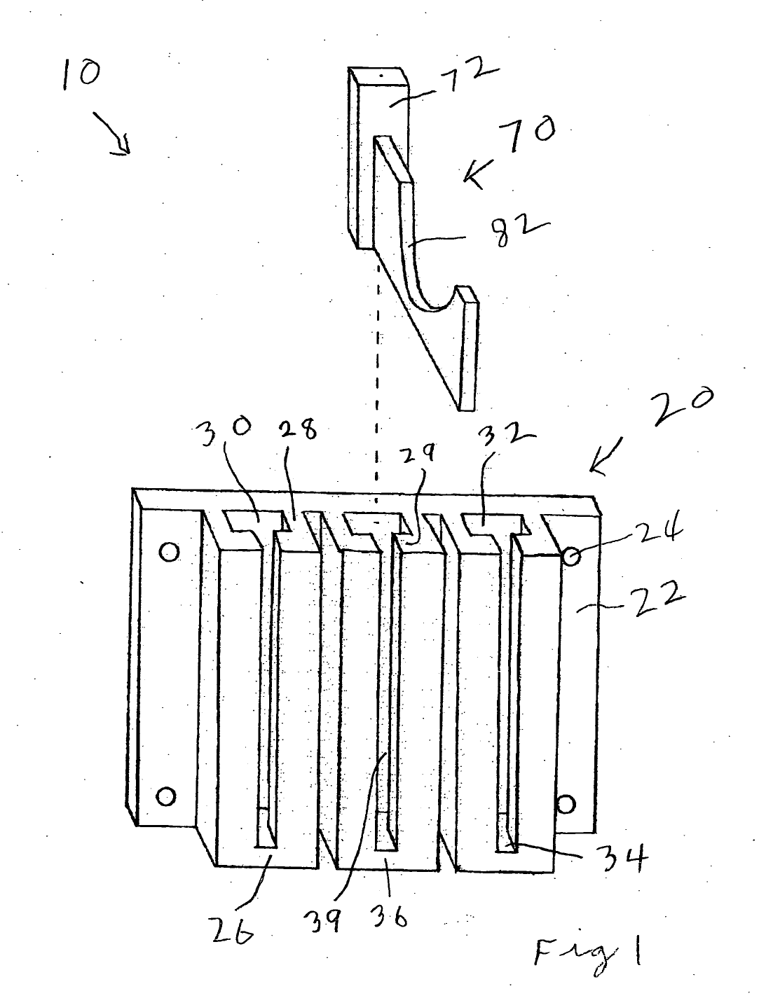

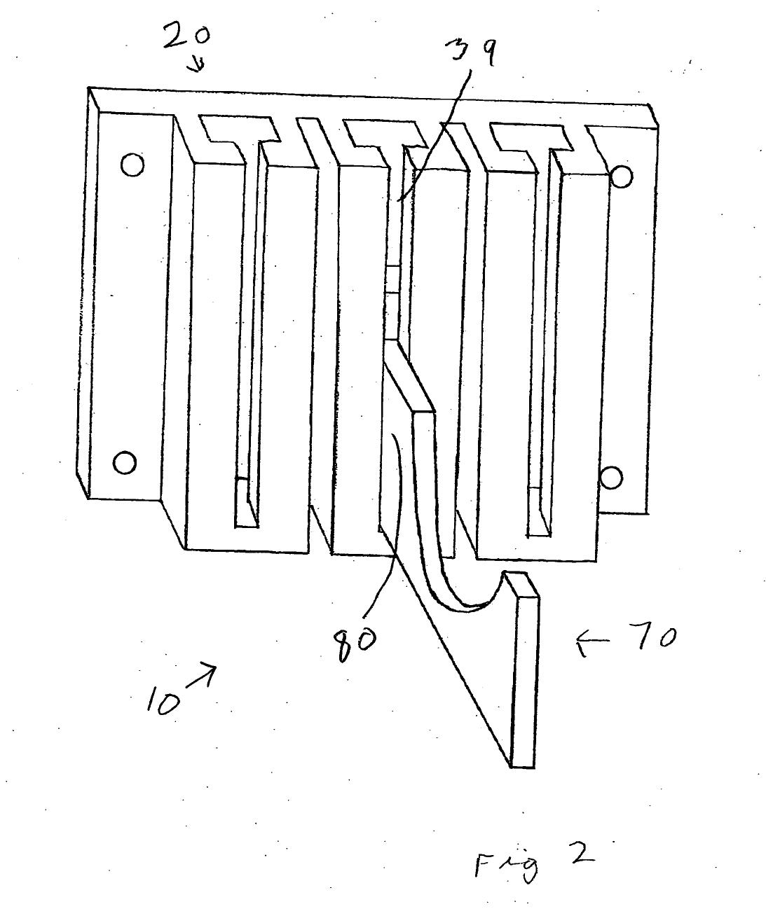

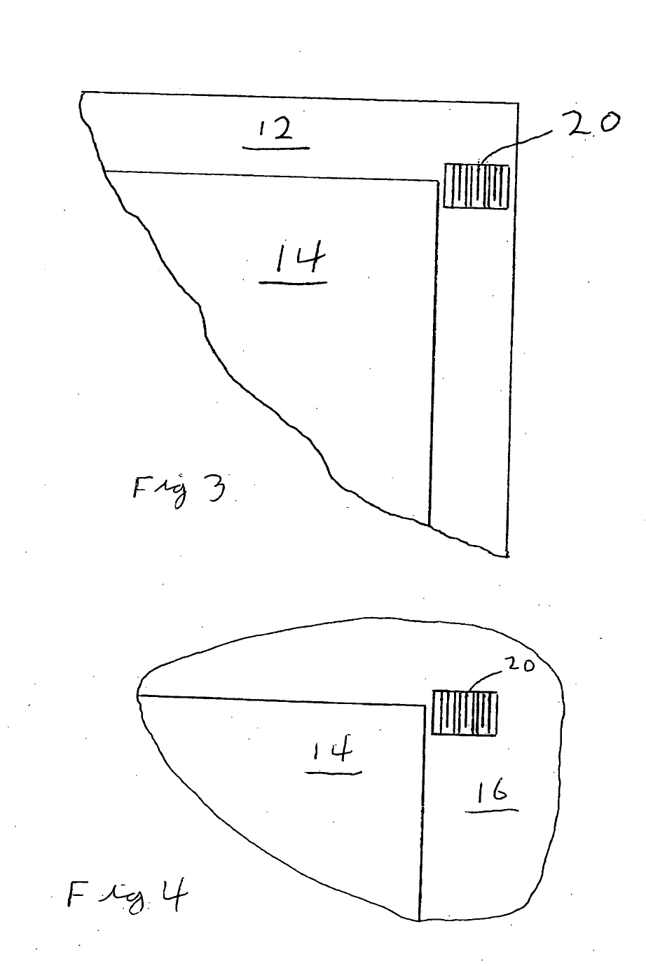

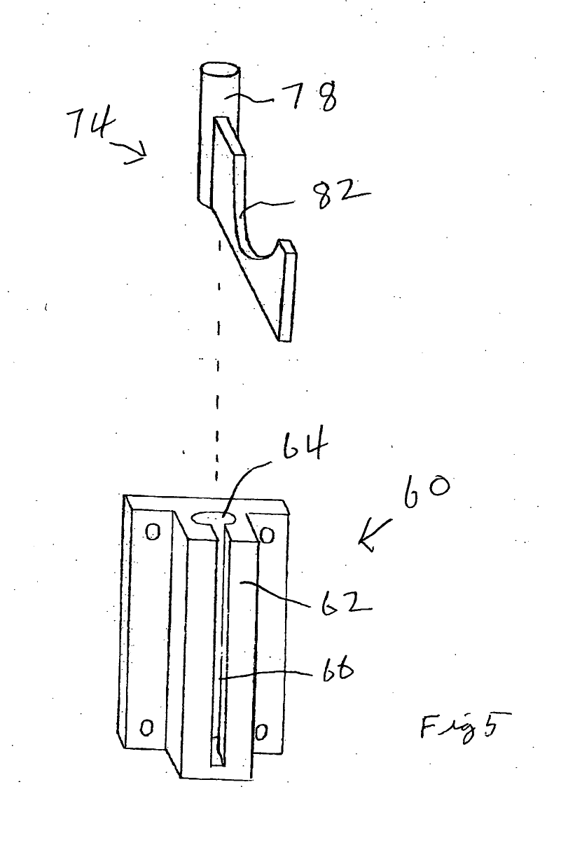

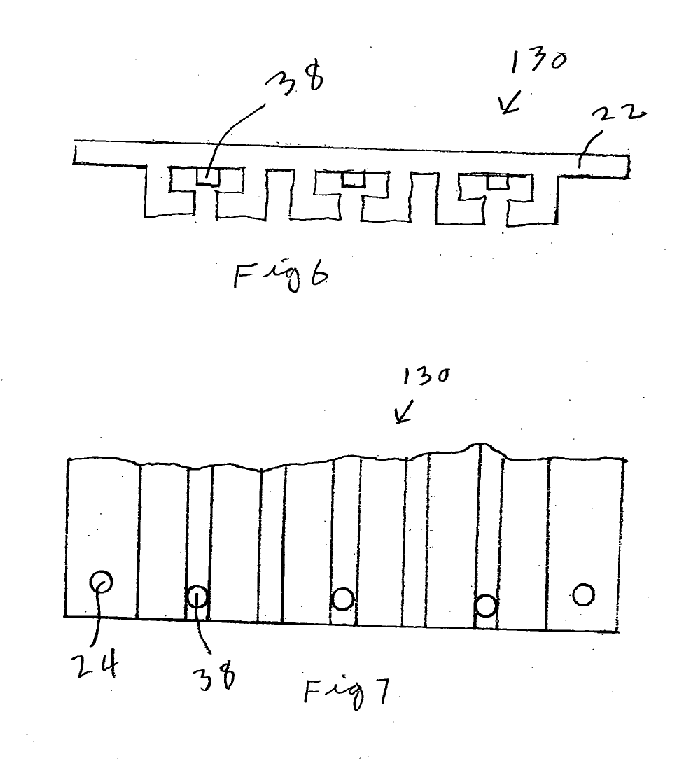

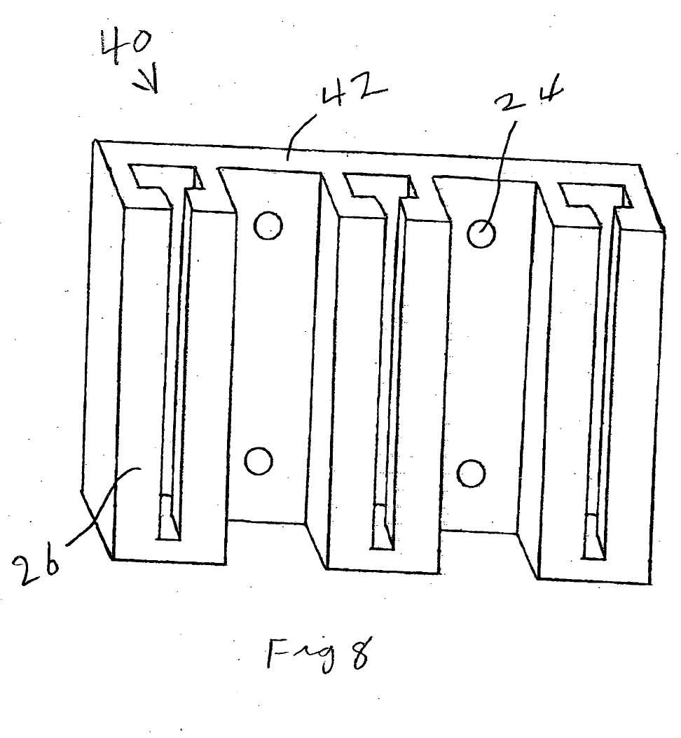

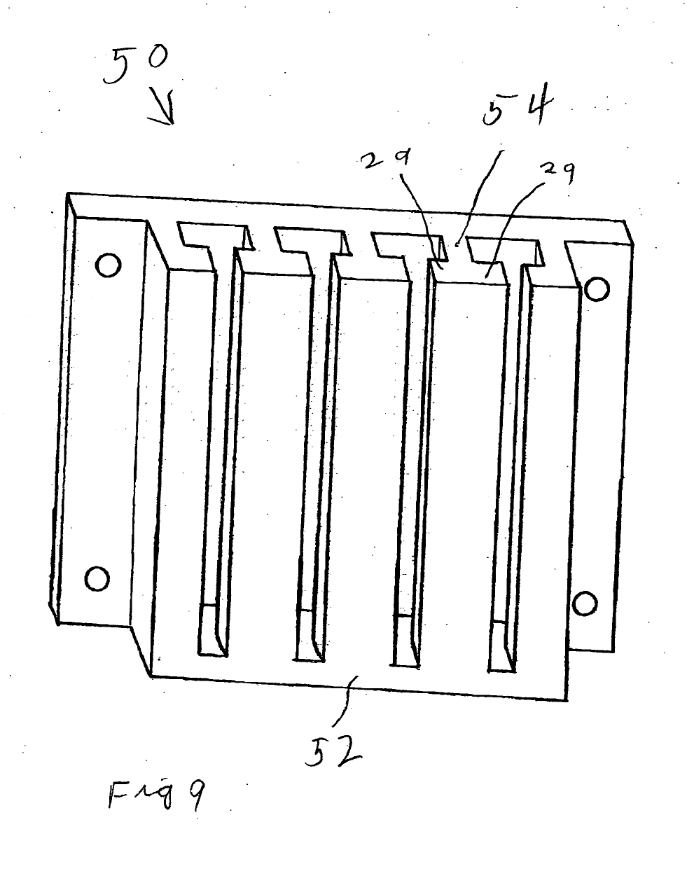

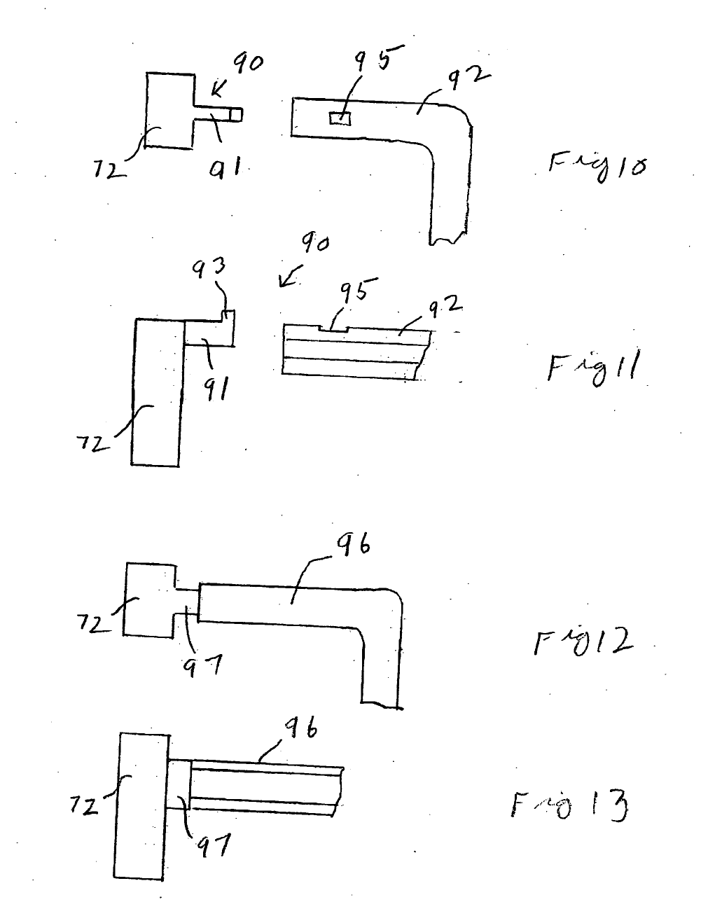

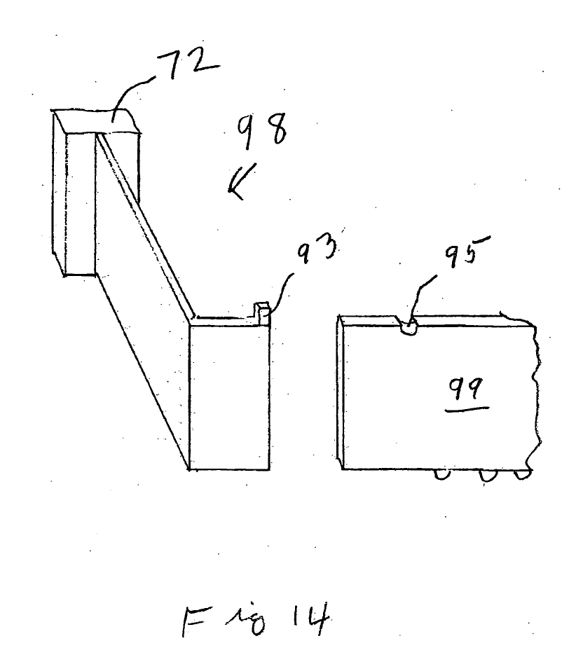

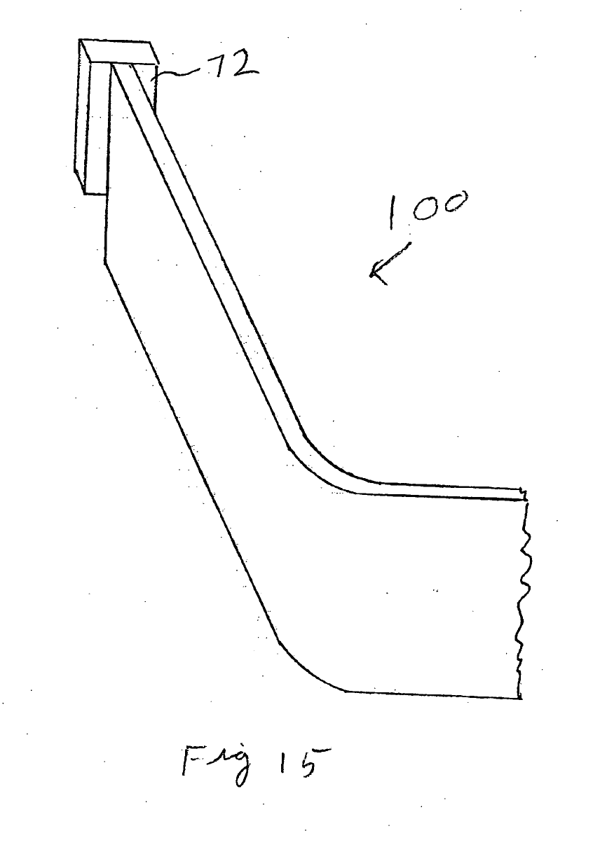

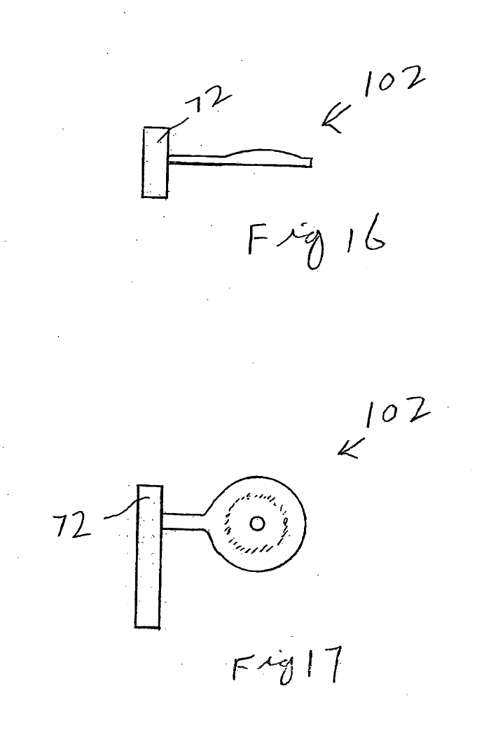

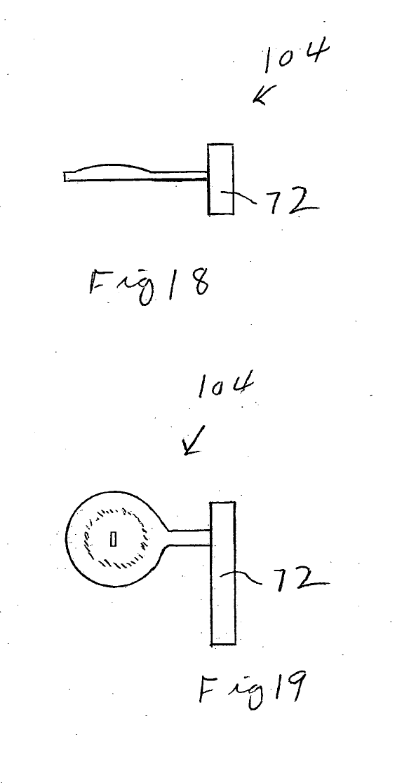

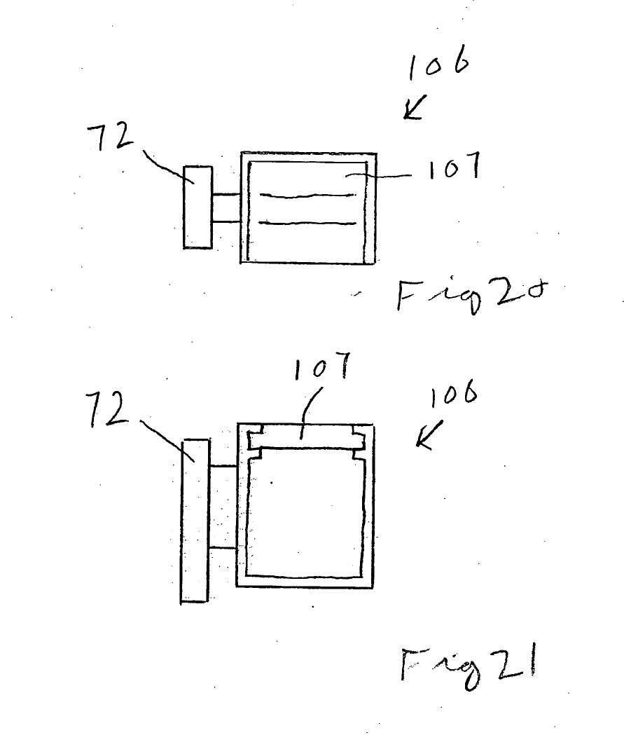

Attention is directed to FIGS. 1 and 2, which illustrate an embodiment of the present invention that is for support of a drapery rod. The invention is a suspension system 10 comprising two basic parts. One is a mounting fixture 20 which is for attachment to a window frame or a wall adjacent a window. The other is a bracket 70 for support of a drapery rod (not shown). Fixture 20 includes a window frame or wall engaging portion, which in this case, is a mounting plate 22 having mounting holes 24. Fixture 20 includes three cavity defining portions 26 which are either attached to or integral with mounting plate 22. In this embodiment, cavity defining portions 26 include ribs 28, each rib having one flange 29. Cavities 30 are defined between ribs 28. Each cavity 30 has a first end 32 that is open and a second end 34 that is closed or blocked. A slot 39 communicates with each cavity 30, the slots being defined between flanges 29.

The bracket 70 includes a cavity engaging portion 72 which may be inserted into one of the cavities 30 through open end 32 of cavity 30. Cavity engaging portion 72 of bracket 70 is supported on closed end 34 of cavity 30. Bracket 70 has a concave support area 82 which is for support of the drapery rod. FIG. 2 illustrates the suspension system 10 with the bracket 70 assembled with the mounting fixture 20. A portion 80 of drapery rod bracket 70 passes outwardly through slot 39.

FIG. 3 shows the mounting fixture 20 attached to a window frame 12 adjacent window 14. FIG. 4 shows the mounting fixture 20 attached to wall 16 adjacent window 14.

FIG. 5 shows a mounting fixture 60 having a cavity defining portion 62 having cylindrical cavity 64. Mounting fixture 60 includes slot 66 communicating with cylindrical cavity 64. Drapery rod bracket 74 has a cylindrical cavity engaging portion 78 for engagement with cylindrical cavity 64.

FIG. 6 illustrates a mounting fixture 130 having blocking members 38 for support of a window treatment component, such as bracket 70 discussed above. Blocking members 38 may be plugs attached to or integral with mounting plate 22.

FIG. 7 shows mounting fixture 130 from the front.

FIG. 8 shows a mounting fixture 40 having mounting plate 42 with mounting holes 24 disposed between adjacent ones of the cavity defining portions 26. Mounting fixture 40 has the advantage that it can easily be hidden by curtains, drapes, or other window treatments which it supports.

FIG. 9 illustrates a mounting fixture 50 including a cavity defining portion 52 having ribs 54 with two flanges 29.

The subsequent figures illustrate various types of window treatment components that are for engagement with a mounting fixture such as or similar to 20, 40, 50 or 60. FIG. 10 shows a top view and FIG. 11 shows a side view of a bracket 90 which is for support of a curtain rod 92 for rod pocket curtains (not shown). A portion 91 of bracket 90 passes through the slot 39, 66 or the like in a mounting fixture according to the present invention. An upward protuberance 93 is for engagement with hole 95 in curtain rod 92.

FIGS. 12 and 13 illustrate a curtain rod 96 having a cavity engaging portion 72 and a portion 97 for passing outwardly through the slot of the mounting fixture.

FIG. 14 illustrates a bracket 98 for a traverse rod 99. An upward protuberance 93 on bracket 98 is for engagement with hole 95 on traverse rod 99.

FIG. 15 illustrates one end of a cornice 100 having a cavity engaging portion 72 disposed thereon. The opposite end of cornice 100 is similar and is not shown. Cornice 100 is for attachment to mounting fixtures such as 20, 40, etc disposed on opposite sides of window 14.

FIGS. 16 and 17 illustrate top and side views of a bracket 102 for the right end of a roll blind (not shown). As before, bracket 102 includes a cavity engaging portion 72, according to the present invention.

FIGS. 18 and 19 illustrate top and side views of a bracket 104 for the left end of a roll blind (not shown). As before, bracket 104 includes a cavity engaging portion 72, according to the present invention.

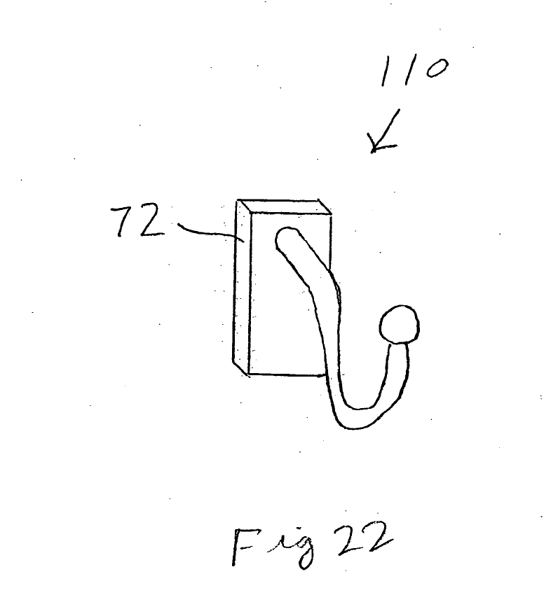

FIGS. 20 and 21 illustrate top and side views of a bracket 106 for Venetian blinds (now shown). Bracket 106 includes a cavity engaging portion 72, according to the present invention. Bracket 106 includes a lid 107 which facilitates assembly with the Venetian blind.

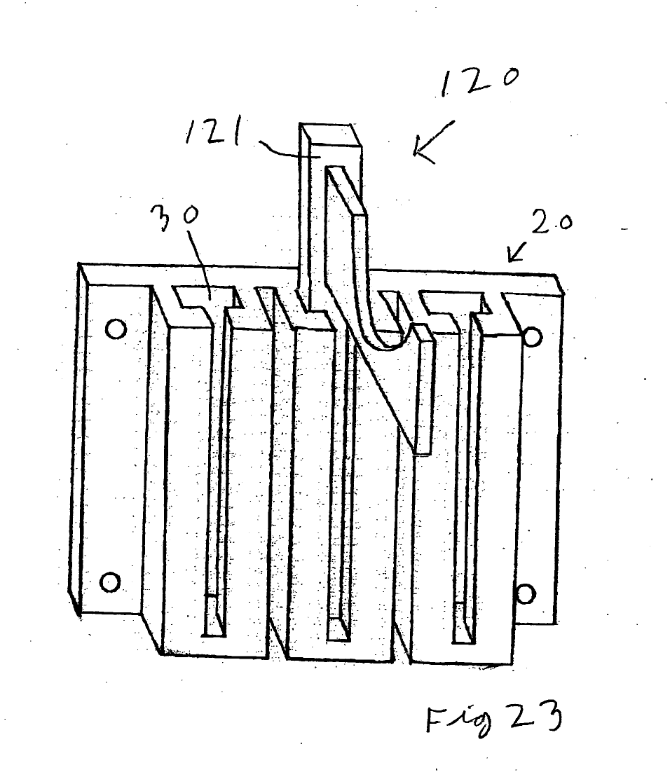

FIG. 22 illustrates a bracket 110 which is for a swag or scarf. As before, bracket 110 includes a cavity engaging portion 72, according to the present invention.

FIG. 23 illustrates a bracket 120 which is to support a drapery rod (not shown) above the top of mounting fixture 20. Bracket 120 includes a cavity engaging portion 122 having a length greater than a length of elongate cavity 30.

While mounting fixtures 20, 40, 50, and 60 have been discussed above in some detail, it should be realized that various other mounting fixtures, in accordance with the present invention, would be obvious to a person skilled in the relevant art, on the basis of this patent. Likewise, whereas the window treatment components such as brackets 70, 74, 90, 98, 102, 104, 106, 110 or 120 or curtain rod 96 or cornice 100 have been discussed in some detail, various other window treatment components having cavity engaging portions such as 72 or 78 would also be obvious to a person skilled in the art, on the basis of this patent. The scope of the invention is, therefore, to be established by the claims as supported by the specification and the figures.

1. A suspension system for curtains, drapes, blinds, swags, scarves, or other types of window treatment, said suspension system comprising:
(1) a mounting fixture comprising:
(a) a window frame or wall engaging portion, said window frame or wall engaging portion being attachable to a window frame or a wall adjacent a window;
(b) at least one cavity defining portion enclosing an elongate cavity, said cavity defining portion being either attached to or integral with said window frame or wall engaging portion;
(c) a slot in said cavity defining portion, said slot communicating with said elongate cavity;
(d) said elongate cavity including a first end and a second end, said first end being open and said second end being closed by an end closure or blocking member;
(e) said mounting fixture being mountable with said elongate cavity substantially vertical, so that said first end is disposed above said second end; and
(2) at least one bracket, rod, cornice or other window treatment component, said at least one window treatment component including a cavity engaging portion for attachment to said mounting fixture by insertion into said cavity through said first end of said cavity, whereby said window treatment component is supported on said end closure or blocking member at said second end of said cavity.

2) A suspension system, according to claim 1, wherein said window treatment component is assemblable with said mounting fixture, with a portion of said window treatment component extending outwardly through said slot.

3) A suspension system, according to claim 1, wherein a length of said cavity engaging portion of said window treatment component exceeds a length of said cavity.

4) A mounting fixture for a suspension system for curtains, drapes, blinds, swags, scarves, or other types of window treatment, said mounting fixture comprising:
(a) a window frame or wall engaging portion, said window frame or wall engaging portion being attachable to a window frame or a wall adjacent a window;
(b) at least one cavity defining portion enclosing an elongate cavity, said cavity defining portion being either attached to or integral with said window frame or wall engaging portion;
(c) a slot in said cavity defining portion, said slot communicating with said elongate cavity;
(d) said elongate cavity including a first end and a second end, said first end being open and said second end being closed by an end closure or blocking member;
(e) said fixture being mountable with said elongate cavity substantially vertical, so that said first end is disposed above said second end; and
(f) said mounting fixture being engageable by at least one bracket, rod, cornice or other window treatment component, said at least one window treatment component including a cavity engaging portion for attachment to said mounting fixture by insertion into said cavity through said first end of said cavity, whereby said window system treatment component is supported on said end closure or blocking member at said second end of said cavity.

5. A mounting fixture, according to claim 4, wherein said window frame or wall engaging portion comprises a plate with mounting holes disposed therein.

6. A mounting fixture, according to claim 4, wherein said elongate cavity is substantially cylindrical.

7. A mounting fixture, according to claim 4, wherein said elongate cavity is substantially rectangular.

8. A mounting fixture, according to claim 7, wherein said cavity defining portion comprises a pair of flanged ribs, said cavity being disposed between said ribs, and said slot being disposed between said flanges on said pair of flanged ribs.

9. A mounting fixture, according to claim 5, wherein said mounting fixture comprises a plurality of cavity defining portions, and at least two of said mounting holes are disposed between adjacent ones of said cavity defining portions.

10. A mounting fixture, according to claim 4, wherein said blocking member is attached to or integral with said window frame or wall engaging portion.

11. A bracket, rod, cornice, or other window treatment component, said window treatment component including a cavity engaging portion for attachment to a mounting fixture, said mounting fixture comprising:
(a) a window frame or wall engaging portion, said window frame or wall engaging portion being attachable to a window frame or a wall adjacent a window;
(b) at least one cavity defining portion enclosing an elongate cavity, said cavity defining portion being either attached to or integral with said window frame or wall engaging portion;
(c) a slot in said cavity defining portion, said slot communicating with said elongate cavity;
(d) said elongate cavity including a first end and a second end, said first end being open and said second end being closed by an end closure or blocking member;
(e) said fixture being mountable with said elongate cavity substantially vertical, so that said first end is disposed above said second end; and
(f) whereby said window treatment component may be assembled with said mounting fixture by inserting said cavity engaging portion of said window treatment component into said cavity through said first end of said cavity.

12. A window treatment component, according to claim 11, said window treatment component comprising a bracket for at least one drapery rod.

13. A window treatment component, according to claim 11, said window treatment component comprising a bracket for at least one curtain rod.

14. A window treatment component, according to claim 13, wherein said curtain rod comprises a rod for rod pocket curtains.

15. A window treatment component, according to claim 13, wherein said at least one curtain rod comprises a traverse rod for curtains.

16. A window treatment component, according to claim 11, said window treatment component comprising a curtain rod, said mounting fixture engaging portion being disposed at an end thereof.

17. A window treatment component, according to claim 11, said window treatment component comprising a cornice, a first one of said mounting fixture engaging portion being disposed at a first end thereof and a second one of said mounting fixture engaging portion being disposed at a second end thereof so that said cornice may be assembled with a pair of mounting fixtures, said mounting fixtures disposed on opposite sides of a window.

18. A suspension system, according to claim 12, wherein said at least one window treatment component comprises a bracket for a roll blind.

19. A suspension system, according to claim 12, wherein said at least one window treatment component comprises a bracket for Venetian blinds.

20. A suspension system, according to claim 12, wherein said at least one window treatment component is a bracket for a scarf or swag.
